(19) United States
(12) Patent Application Publication
(10) Pub. No.: US 2026/0115876 A1
(43) Pub. Date: Apr. 30, 2026

(54) Torque wrench

(71) Applicant: Zhejiang Shinman Tools Co., Ltd, Shaoxing (CN)

(72) Inventors: Jun SHAO, Shaoxing (CN); Liang HUA, Shaoxing (CN); Linwei XUE, Shaoxing (CN)

(73) Assignee: Zhejiang Shinman Tools Co., Ltd, Shaoxing (CN)

(21) Appl. No.: 18/930,821

(22) Filed: Oct. 29, 2024

(51) Int. Cl. B25B 23/142; B25B 13/06; B25B 23/14

(52) U.S. Cl. CPC B25B 23/1427; B25B 23/141; B25B 13/06

(57) ABSTRACT

The present invention discloses a torque wrench, belongs to the technical field of wrenches and addresses the problem that the machining error of existing wrenches is big, and the technical solution is: the torque wrench comprises a handle, a steel tube is connected with the handle, a drive head is provided at another end of the steel tube, the torque wrench further comprising: an adjusting screw rod, the adjusting screw rod is provided in the handle, the adjusting screw rod is connected with a torque spring, an end of the torque spring is provided in the handle, and another end of the torque spring is in the steel tube; a first sliding body, a second sliding body is provided in the first sliding body, the second sliding body is connected with a drive block, the drive block is connected with a collision block, the first sliding body, the second sliding body and the collision block are provided in the steel tube, the first sliding body is connected with a sliding spring, sliding is allowed in between the first sliding body and the second sliding body, and in this way, machining error can be reduced.

### TECHNICAL FIELD

The present invention relates to the technical field of wrenches, specifically a torque wrench.

### BACKGROUND TECHNOLOGY

The torque wrench is also called a torque spanner or torque adjustable wrench, and is a kind of wrench. Depending on the power source, the torque wrenches can be divided into electric torque wrenches, pneumatic torque wrenches, hydraulic torque wrenches, manual torque wrenches and digital torque wrenches; the manual torque wrenches can include preset torque wrenches, fixed value torque wrenches, dial torque wrenches, digital torque wrenches, slipping torque wrenches, bending beam torque wrenches and kilogram torque wrenches. Where tightness of screws and bolts is vital, by using a torque wrench, a specific torque can be applied.

Structures of existing torque wrenches comprise the torque wrenches and connection sockets, after setting the torque with a torque wrench, screw off the nut using a socket, the socket connected with the torque wrench can be replaced according to the dimension of the nut, a required socket can be used, after use, remove the socket to store individually.

The existing sliding block is directly in contact with the steel tube, due to wearing against the tube, the tube is worn, after that, the accuracy is changed, sliding of the steel balls cannot be promised, the assembly process is complex, and being in direct contact with the tube, the tube is liable to wear off, and accuracy will be affected.

### SUMMARY OF THE INVENTION

In view of the deficiency of the prior art, the present invention aims to provide a torque wrench, to address the problem existing in the prior art.

To realize the foregoing purpose, the present invention provides the following technical solution:

A torque wrench, comprising a handle, a steel tube is connected with one side of the handle, a drive head is provided at another side of the steel tube, the torque wrench further comprising:

An adjusting screw rod, wherein the adjusting screw rod is provided in the handle, the adjusting screw rod is connected with the torque wrench, at least one torque spring is connected with the adjusting screw rod, an end of the at least one torque spring is provided in the handle, another end of the at least one torque spring is provided in the steel tube, and the at least one torque spring is configured to transmit power;

A first sliding body, a second sliding body is provided in the first sliding body, the second sliding body is connected with a drive block, the drive block is connected with a collision block, the first sliding body, the second sliding body and the collision block are provided in the steel tube, the first sliding body is connected with a sliding spring, and sliding is allowed in between the first sliding body and the second sliding body.

As a further technical solution, a groove is provided at a side of the second sliding body, and the drive block is movably connected in the groove.

As a further technical solution, at least one positioning groove is provided in the groove, and the at least one positioning groove is configured to promise direction stability.

As a further technical solution, the handle is connected with the steel tube via a torque locking ring, and the torque locking ring is configured to snap the steel tube.

As a further technical solution, the steel tube is connected with the drive head via a transmission pin.

Above all, embodiments of the present invention have the following beneficial effects compared with the prior art:

In the present invention, by rotating the handle, the handle can drive the adjusting screw, the adjusting screw can compress and release the at least one torque spring, by adjusting the torque, by the at least one torque spring, the force is transmitted from the torque spring to the first sliding body, and to the drive block, and the drive block relatively contact the collision block.

After that, by transmitting the force of the drive head to the screws and the screw rod, the force of the drive head is transmitted via the transmission pin and the drive head pivots against the transmission pin, when the force reaches the force set by the at least one torque spring, the drive block will turn laterally, the at least one torque spring will be compressed, after releasing, the at least one torque spring will resume to the original position.

To illustrate the structural features and technical effects of the present invention more clearly, hereinafter a detailed description will be given to the embodiment in conjunction with the drawings.

### BRIEF DESCRIPTION OF DRAWINGS

FIG. 1 is a structural diagram showing an embodiment of the present invention.

FIG. 2 is a structural diagram showing a first sliding body according to an embodiment of the present invention.

FIG. 3 is a structural diagram showing a groove according to an embodiment of the present invention.

Markups in the drawings are: 1 handle; 2 adjusting screw rod; 3 torque spring; 4 torque locking ring; 5 first sliding body; 6 collision block; 7 steel tube; 8 sliding spring; 9 drive block; 10 transmission pin; 11 drive head; 12 second sliding body; and 13 groove.

### EMBODIMENTS

To make the purpose, technical solutions and advantages of the present invention more clear and apparent, hereinafter with reference to the drawings and embodiments, a further detailed description will be given to the present invention. It shall be understood that, the embodiments given here are only for the purpose of explaining the present invention rather than to restrict the present invention.

Hereinafter a detailed description will be given to embodiments of the present invention.

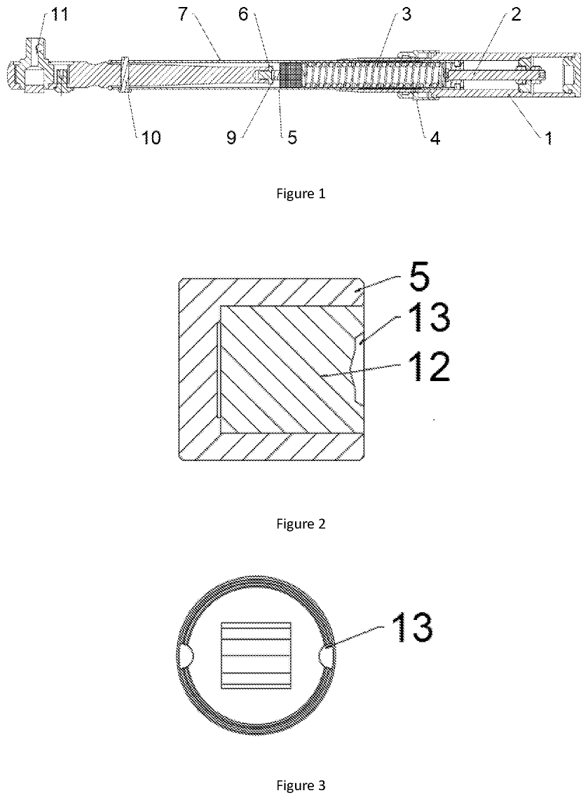

In an embodiment, a torque wrench, with reference to FIGS. 1-3, comprising a handle 1, a steel tube 7 is connected with the handle 1, and a drive head 11 is provided at another side of the steel tube 7, the torque wrench further comprises:

An adjusting screw rod 2, the adjusting screw rod 2 is configured in the handle 1, the adjusting screw rod 2 is connected with at least one torque spring 3, an end of the at least one torque spring 3 is provided in the handle 1, another end of the torque spring 3 is provided in the steel tube 7, and the at least one torque spring 3 is configured to transmit power;

A first sliding body 5, a second sliding body 12 is provided in the first sliding body 5, the second sliding body 12 is connected with a drive block 9, the drive block 9 is connected with a collision block 6, and the first sliding body 5, the second sliding body 12 and the collision block 6 is configured in the steel tube 7.

In the present embodiment, by rotating the handle 1, driving the adjusting screw rod 2 with the handle 1, the adjusting screw rod 2 compresses and releases the at least one torque spring 3, by adjusting the torque and applying a force on the at least one torque spring 3 the force is transmitted to the first sliding body 5, then to the drive block 9, and the drive block 9 contacts the collision block 6;

After that, by transmitting the force of the drive head 11 to the screw and the screw rod, the force of the drive head 11 is transmitted via the transmission pin 10, the drive head 11 pivots against the transmission pin 10 for axial movement, where the torque reaches the value required for the at least one torque spring 3, the drive block 9 will turn laterally, the at least one torque spring 3 will be compressed, upon releasing, the at least one torque spring 3 resumes to the original position.

In an embodiment, with reference to FIGS. 1-3, the first sliding body 5 is connected with a sliding spring 8, and the first sliding body 5 is slidable against the second sliding body 12 and vice versa.

In the present embodiment, the first sliding body 5 and the second sliding body 12 cooperate tightly to function integrally, errors due to the gap are not liable to occur, the second sliding body 12 is short, friction is reduced and stability of the friction coefficient is promised. For friction due to deformation, the first sliding body 5 comprises high alloy materials, the second sliding body 12 comprises self-lubricating clinkers, and mutual wearing is nearly zero.

The friction coefficient is relatively stable during force transmission. In this way, the product accuracy can be effectively promised, during releasing the force, the sliding bodies are relatively moving, the second sliding body 12 contacts the tube, the first sliding body 5 is integral, the second sliding body 12 comprises self-lubricating materials, and friction stability is promised.

Further, with reference to FIGS. 1-3, at least one groove 13 is provided in the second sliding body 12, and the at least one groove 13 is movable connected with the drive block 9.

Further, with reference to FIGS. 1-3, at least one positioning groove is provided in the at least one groove 13, and the at least one positioning groove is configured to promise direction stability.

Further, with reference to FIGS. 1-3, the handle 1 is connected with the steel tube 7 via a torque locking ring 4, and the torque locking ring 4 is configured to snap the steel tube 7.

Further, with reference to FIGS. 1-3, the steel tube 7 is connected with the drive head 11 via the transmission pin 10.

In the present embodiment, four fixing grooves are provided in the at least one groove 13 for positioning, in this way, the direction of the second sliding body 12 can be controlled effectively, the directional stability can be promised, by completing the direction orientation, good control can be given to the contact surfaces of the product, the second sliding body 12 is hollow inside, the machining error can be reduced and by making the sliding body hollow the tolerance can be reduced;

At least one positioning groove can be provided in the at least one groove 13, the number of the at least one positioning groove is not limited, and a shape of the at least one positioning groove is not fixed, only if the at least one positioning groove can reach the direction of the second sliding body 12 and promise directional stability;

Direction orientation can realize good control on the contact surfaces of the product, the first sliding body 5 is made of high density alloy material, the second sliding body 12 is made of self-lubricating materials, friction in between the steel tube and the sliding bodies can be addressed, the friction between the steel tube and the sliding bodies can be addressed, the friction between the first sliding body 5 and the steel tube 7 is addressed by separating the first sliding body 5 and the steel tube 7, and the second sliding body 12 serves for lubrication and addresses the high friction coefficient of steel parts.

The foregoing are only some preferred embodiments of the present invention, and are not configured to limit the present invention, all modifications, equivalent replacements and improvements made within the spirit and principle of the present invention fall into the protection scope of the present invention.

1. A torque wrench, comprising a handle, a steel tube is connected with one side of the handle, a drive head is provided at another side of the steel tube, the torque wrench further comprising:
an adjusting screw rod, wherein the adjusting screw rod is provided in the handle, the adjusting screw rod is connected with the torque wrench, at least one torque spring is connected with the adjusting screw rod, an end of the at least one torque spring is provided in the handle, another end of the at least one torque spring is provided in the steel tube, and the at least one torque spring is configured to transmit power;
a first sliding body, a second sliding body is provided in the first sliding body, the second sliding body is connected with a drive block, the drive block is connected with a collision block, the first sliding body, the second sliding body and the collision block are provided in the steel tube, the first sliding body is connected with a sliding spring, and sliding is allowed in between the first sliding body and the second sliding body.

2. The torque wrench according to claim 1, wherein a groove is provided at a side of the second sliding body, and the drive block is movably connected in the groove.

3. The torque wrench according to claim 2, wherein at least one positioning groove is provided in the groove, and the at least one positioning groove is configured to promise direction stability.

4. The torque wrench according to claim 1, wherein the handle is connected with the steel tube via a torque locking ring, and the torque locking ring is configured to snap the steel tube.

5. The torque wrench according to claim 1, wherein the steel tube is connected with the drive head via a transmission pin.
